(19) United States
(12) Patent Application Publication
(10) Pub. No.: US 2022/0414621 A1
(43) Pub. Date: Dec. 29, 2022

(54) BLOCKCHAIN AND NON-FUNGIBLE TOKEN APPLICATION IN A GAMING ENVIRONMENT TO STORE AND TRACK DIGITAL ASSETS

(71) Applicant: E2INTERACTIVE, INC., Atlanta, GA (US)

(72) Inventors: MICHAEL PARLOTTO, SANDY SPRINGS, GA (US); GEORGE W HARBINSON, CUMMING, GA (US)

(21) Appl. No.: 17/851,456

(22) Filed: Jun. 28, 2022

Related U.S. Application Data
(60) Provisional application No. 63/216,320, filed on Jun. 29, 2021.

(51) Int. Cl. G06Q 20/06; G06F 21/60; G06Q 20/38; H04L 9/00

(52) U.S. Cl. CPC G06Q 20/065; G06F 21/602; G06Q 20/38215; H04L 9/50

(57) ABSTRACT

The present invention is directed to systems and methods for utilizing blockchain and non-fungible tokens in a gaming environment. In accordance with some embodiments, a method of transferring ownership of a digital asset between a provider of the asset, a receiver of the asset, and multiple nodes in a distributed file system, may include: assigning a non-fungible token (NFT) to the asset; recording the NFT on the distributed file system; receiving a request for transfer of the asset from the provider to the receiver; confirming ownership of the asset by reviewing the NFT record;

transferring ownership of the asset from the provider to the receiver; updating the NFT record on one or more nodes in the distributed file system to reflect receiver as the owner of the asset; and confirming the receiver as the owner of the asset by one or more other nodes in the distributed file system.

### RELATED APPLICATIONS

This application depends on and claims priority to U.S. Provisional Patent Application Ser. No. 63/216,320, filed on 29 Jun. 2021 and entitled “Blockchain and Non-Fungible Token Application in Gaming Environment to Store and Track Digital Assets,” which is incorporated herein by reference in its entirety.

### BACKGROUND

Virtual assets are rising in both use and value. Ranging from digital works and media such as songs, non-fungible token (NFT) artworks and videos to assets in gaming environments, virtual assets are becoming more relevant in everyday life. However, there are significant issues with regard to such assets. For example, such assets are difficult to protect from fraud, and authenticity may be difficult to verify. In addition, although such assets may have significant value, there are limited mechanisms for sale and transfer of assets to other parties, and existing mechanisms are fraught with security issues.

### SUMMARY OF THE INVENTION

In accordance with some embodiments of the present invention, aspects may include a method of transferring ownership of a virtual or digital asset between a provider of the asset, a receiver of the asset, and multiple nodes in a distributed file system, the method comprising: assigning a non-fungible token (NFT) to the asset; recording the NFT on the distributed file system; receiving a request for transfer of the asset from the provider to the receiver; confirming ownership of the asset by reviewing the NFT record on one or more nodes in the distributed file system; transferring ownership of the asset from the provider to the receiver; updating the NFT record on one or more nodes in the distributed file system to reflect receiver as the owner of the asset; and confirming the receiver as the owner of the asset by one or more other nodes in the distributed file system.

These and other aspects will become apparent from the following description of the invention taken in conjunction with the following drawings, although variations and modifications may be effected without departing from the scope of the novel concepts of the invention.

### DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 depicts an exemplary distributed network system, in accordance with some embodiments of the present invention.

FIG. 2 depicts an exemplary distributed network system, in accordance with some embodiments of the present invention.

FIG. 3 depicts an exemplary distributed network system, in accordance with some embodiments of the present invention.

FIG. 4 depicts an exemplary distributed network system, in accordance with some embodiments of the present invention.

FIG. 5 depicts an exemplary distributed network system, in accordance with some embodiments of the present invention.

FIG. 6 depicts exemplary blocks of data, in accordance with some embodiments of the present invention.

### DETAILED DESCRIPTION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

As noted above, virtual assets are rising in both use and value. Ranging from digital works and media such as songs, non-fungible token (NFT) artworks and videos to assets in gaming environments, virtual assets are becoming more relevant in everyday life. A non-fungible token is unique non-interchangeable data that may be stored, sold, and traded using blockchain technology. Files and ledgers of NFT data may be used to prove ownership of a digital asset.

Before proceeding to discuss the various technical aspects and transactions conducted and supported by systems and methods in accordance with some embodiments of the present invention, it may useful to first discuss some of the relevant overarching technologies and fields of art.

Blockchain. In general, a blockchain is a distributed public ledger. The public ledger includes all transactions that have been executed and is continually growing as completed blocks are added. Blocks are sequentially added to the blockchain in a linear, chronological order. Each block contains a hash of the previous block, as well as other data such as a time stamp and information representing a Merkle tree of the block.

As noted, blocks include a hash, generated using a cryptographic hash function, which is a mathematical algorithm that maps data into a bit array of a fixed size. Data in a block can be confirmed to be authentic through verification of message integrity—in short, comparing hashes calculated before and after transmission to verify that nothing has been changed. Each event transferring ownership from one party to another may be cryptographically proofed by including a public key of the new owner. Each event may also be digitally signed with a private key from a current owner, thereby indicating consent to the transfer.

A new block in a blockchain is filled with cryptographically proofed events until the block reaches a specified size limit. A hash digest of all the event identifiers within the block and the block header of the previous block are added as the first event in the block.

Each block may therefore be confirmed and difficult to modify. A series of blocks—or blockchains where each block depends on the blocks before it and any modification to previous blocks would alter all subsequent blocks renders the data structure quite secure and very resistant to being modified.

Because blockchains may be distributed over a public ledger, management of the blockchain is decentralized and distributed over computer systems. In some systems and embodiments, such computer systems may be operated by numerous entities who may be anonymous who contribute their computing power to the system. In some embodiments computer systems may be run by known entities (e.g., a private blockchain), but the decentralized nature of the chain remains.

Distributed contributors provide the infrastructure of the blockchain system by storing copies of the blockchain, and performing the algorithms necessary to process transactions, deploy them into new blocks on the blockchain, and distribute those blocks to other parts of the system.

In accordance with some embodiments, some computer systems, such as a player's computer or user wallets may only view the transactions and balances on the ledger. Other computer systems may amend the ledger and confirm amendments. Moreover, the ledger may be permissioned, in which case only certain computers are given access or specific access. In this manner, a single blockchain may be utilized to provide transfer amongst unrelated gaming systems, without necessarily sharing data that is otherwise confidential to a specific gaming platform.

In some blockchain systems, contributors are compensated for providing computer systems to process, verify, and generate new blocks by receiving a fee. Typically, such fees are denominated in a cryptocurrency associated with the blockchain (e.g., BitCoin, Ether, etc.).

Blockchain technology forms the basis for decentralized cryptocurrencies, which are expanding in application and acceptance. Cryptocurrencies may augment or replace existing payment methodologies. Notably, and unlike fiat money issued and backed by a single party (such as a government), cryptocurrencies utilize decentralized system for processing transfers and exchange.

In some implementations of a blockchain, the encrypted data may include programs such as self executing digital contracts, known as Smart Contracts. Smart Contracts are not true contracts that are negotiated and signed, but rather programs stored on a blockchain that automatically run when predetermined conditions are met. Smart Contracts may be used to automate execution of an agreement without any intermediary involvement or time loss. In this manner, parties may be certain that an exchange will occur without delays or tampering. For example, if a Smart Contract is programed to provide the transfer of a digital asset once a certain price threshold is met, once the price threshold is met the Smart Contract will automatically execute, withdrawing value from the buyer and providing to seller while simultaneously transferring ownership of the asset to the buyer. Neither party is exposed to loss and the use of a third party (such as an escrow agent) is unnecessary.

This technology may be implemented using known blockchain technology, such as but not limited to Blockchain, Ethereum, NEO, OpenChain, Hyperledger (Fabric, Sawtooth, Hashgraph, Iroha, etc.), Tezos, Stellar, etc. Selection of a specific blockchain technology may be dependent upon the needs of the specific system. For example, the use of Smart Contracts may direct the use of platforms capable of such elements, including Ethereum, Hyperledger, EOS, OpenChain, Stellar, etc. For example, utilizing Ethereum, fungible assets may be converted to ERC20-compliant or ERC223-compliant tokens and non-fungible assets may be converted to ERC721-compliant tokens.

However, those of ordinary skill in the art will appreciate that the specific technologies discussed above, specific tokens and contract standards are exemplary and that new standards will emerge that may be used to provide transactions for new cryptocurrency tokens.

Virtual Assets. In short, a virtual or digital asset may be any information that can be stored, transmitted, interpreted, and used that is encoded in a digital or numeric format, including without limitation information encoded as binary data. Examples of digital assets may include digital documents, encoded audio, video, or text, executable code in various formats, and any other type of information. Virtual assets may be virtual currencies (e.g. gems, gold, coins, New York Dollars, ‘credits’), avatars, avatar skins, avatar tools, or game environments. These assets are normally only relevant to a single game and held within that game's platform They are neither Fiat money, nor typically exchangeable outside of the respective game. In-game, virtual assets may be earned by user achievements, simply playing and obtaining points (earned) or purchased with fiat currency (premium). The virtual assets may be fungible (e.g. game coins that are indistinguishable and exchangeable for another coin or easily traded for another assets) or non-fungible (e.g. special or even unique game rewards that are distinguishable from other assets and not easily traded for other assets).

In general, the present applications relates to the exchange of digital assets, wherein systems effectuating the transfer or exchange utilizes blockchain technology. In some embodiments, there may be marketplaces, listings, etc. for digital assets currently for sale. Verification and authentication of the assets and the ownership may be confirmed, and the transfer conducted, using and approved by blockchain technology.

There is a large market for digital assets, and systems are desirable that may allow parties to buy and sell digital assets, such as virtual items for video games. However, there are several issues restricting the growth of a large marketplace for exchanging digital assets. Notably, lack of trust in marketplace and high transaction costs have greatly contributed to inhibiting such an exchange platform. Lack of trust may stem from occurrences of theft and fraud, as well as the fact that typically the transfer of the digital asset and the payment of value are not directly linked and require an element of trust between the parties. High transaction costs may be due to several factors, including the fact that parties are not necessarily in the same geographic area or country, and accordingly value transfers typically incur various fees (wires fees, bank transfer fees, cross-border fees, etc.).

Gaming. As noted above, virtual assets may include various gaming elements. As gaming has advanced and grown, the ability to trade, buy, and sell various in-game digital assets has developed. Yet, while some games have permitted or even promoted transfer of in-game assets, such transfers generally use centralized servers associated with the individual game as intermediaries to ensure that transactions are valid and fair. However, the use of centralized servers may affect reliability and security. For example, centralized servers may be compromised by a malicious party. Verification of authenticity and ownership may be difficult. Relying upon a centralized game server to store and verify provenance of a digital asset may be unreliable and incomplete.

Currently, it has been newsworthy that many smaller gaming systems and platforms have been purchased or acquired by larger entities. Therefore, various parties may now maintain a multitude of gaming platforms, including dedicated gaming consoles, personal computers (PC), and more recently, cloud gaming and mobile devices. Since games often require or encourage the use of virtual assets within the context of the video game, such virtual assets may be increasingly valuable. Networked gaming services and systems have struggled to provide adequate systems to handle the sale and trade of virtual assets while also protecting users against fraudulent transactions. It has been estimated that about 1 in 8 virtual items is lost to fraud.

Moreover, once a user finishes a game, their assets are useless as they may only be used within that single game. There is no mechanism to exchange virtual currency to other gaming platforms or for different forms of value.

In accordance with some embodiments of the present invention, systems and methods may provide for the transfer and sale of virtual assets via blockchain technology, thereby providing a secure transfer and enabling tracking of transactions that have taken place in relation to a specific virtual asset. The use of self-executable smart contracts may further the faith of users, as well as reducing any delays in the transfer. In accordance with some embodiments, transactions can be stored on a public blockchain. For example, encrypted data can be stored to a public blockchain (e.g. Ethereum blockchain, BitCoin blockchain, etc.) and a transaction number is obtained. The legitimacy of the data (e.g. for a virtual asset transaction) can be verified using a hash key match, enabling verification of data/transactions by users.

For example, if a user purchases a digital asset from another user, a hash value can be created using details of the transaction and stored on a blockchain. Multiple machines computing transactions may then ensure the integrity of the transaction. Blockchain hashing of the transaction can be employed, and multiple nodes may reach a consensus as to its validity (for example, through a majority vote) to ensure a particular hash value is authentic.

Because asset provenance is recorded in the blockchain, even if an asset changes multiple hands, if it was stolen or fraudulently obtained, it can be returned to the proper owner. In some embodiments, each virtual asset may have a unique or semi-unique identifier. This virtual asset identifier may be hashed along with a nonce or private key, generating a blockchain signature. If the virtual asset is misappropriated, restoring or returning the virtual asset to the proper owner may be straightforward, since the original owner can be identified using the identifier.

It is noted that virtual assets may be misappropriated through a fraudulent party illegally accessing a user's account. This may be through hacking, phishing, brute-force approaches to low security passwords, etc. Fraudulent parties may then transfer virtual assets either to their own account, or to an intermediary account before selling. However, logging all transactions to a blockchain creates a permanent and unalterable record of the fraud. Fraudulent activity may be quickly identified, and accounts of fraudulent parties may also identified. Actions may then be taken against the fraudulent party and/or fraudulent account, such termination from the game, a freeze on their virtual assets, engagement of local law enforcement, etc.

In accordance with some embodiments of the present invention, a gaming platform may store a copy of a blockchain ledger with multiple blocks, associated with a particular game or virtual asset. A gaming platform may receive a request of a transaction of a virtual asset or in-game currency. The gaming platform may verify that the intended transaction is valid and generate a new block that includes the transaction data. The new block may include a header comprising a hash of the previous block, thereby tying the new block to the chain. This new block may then be sent to other nodes of the blockchain, and once a consensus is reached, considered valid and authentic.

When a user device—such as a Players personal computer (PC)—receives a message identifying an intended transaction of a virtual asset, player's PC may access the blockchain (even in a read-only environment) and verify that the intended transaction is valid.

Gaming systems may comprise various gaming platforms which may communicate with players' PCs or consoles. Video game consoles may comprise any device that outputs a video signal and displays a game played by a game controller. While video game consoles (such as PlayStation or Xbox) are game-driven, they are in essence computers. Accordingly, the term “Player's PC” shall be seen to include various video game consoles that have communicative abilities, for example networked or operating over the internet, including but not limited to consoles, computers, smartphones, tablet computers, etc. Gaming platforms may comprise one or more gaming servers that may host software for playing electronic games. A gaming server may host multiple games, and games may be hosted by multiple servers to balance loads and reduce game latency. Games may be operated by the publisher of the gaming software or distributed by third parties, such as Google™ Play, iTunes™, and/or Steam™.

Users may have an account with the gaming platform, which may store virtual assets and/or in-game currency. User accounts may be tied to or associated with a digital wallet which may be programmed to read a user's balance of digital assets. In accordance with some embodiments of the present invention, a user's digital wallet may be used for multiple games and multiple gaming platforms. In some embodiments, a user's digital wallet may be used for virtual non-gaming assets, such as digital copies of songs, videos, artwork, etc. It is contemplated that a user's digital wallet may be a smart wallet, programmed as smart contracts on the distributed ledger or automatic execution and fulfillment of “contracts” when conditions are met.

Normally the gaming server may issue or sell virtual assets solely for use in that game, potentially without limit or traceability. In the present system, each gaming server accesses a ledger of users and assets, which may span multiple games, gaming platforms, and parties. Data on the ledger may be encrypted and usable only by relevant and authorized parties, but various parties may confirm validity of the data by calculating and confirming the blockchain. Transfers may then be effectuated, for example via smart contracts, as discussed above.

Overview. Exemplary rules for transactions include, but are not limited to, (i) the purchaser has the digital asset or enough of the digital asset to be sent as payment for the acquired asset; (ii) the seller has the digital asset or enough of the digital asset to be sent to the purchaser; (iii) the blockchain records a previous transaction or purchase of the virtual asset toward the current seller; and (iv) the seller has not already transferred the digital asset to be sent to another.

Such a transaction may also be in the form of a smart contract, which may include identification of a virtual asset, seller's identification, conditions to be satisfied (e.g., price, etc.) and other conditions. Once conditions are met, the smart contract may execute and automatically provide for the transfer of the virtual asset.

As noted above, in some embodiments of the present invention, systems and methods may be utilized to provide for transfer of virtual assets between different systems. For example, assets may be transferred between two unassociated gaming platforms—such as points, value, or items. In addition, assets may be transferred from unrelated parties—such as importing a digital song from a music provider into a gaming platform so that the song may be listened to while playing on the gaming platform.

Note that while an item is listed for transfer, it may be removed from its current status to be available for transfer. For example, if a player wishes to list a vehicle in a peer-to-peer marketplace, the vehicle may be removed from the player's account and posted on the blockchain along with smart contract terms for its transfer and sale. In accordance with some embodiments, the player may continue to use the virtual asset, but if the smart contract is executed, it may immediately be withdrawn from the player.

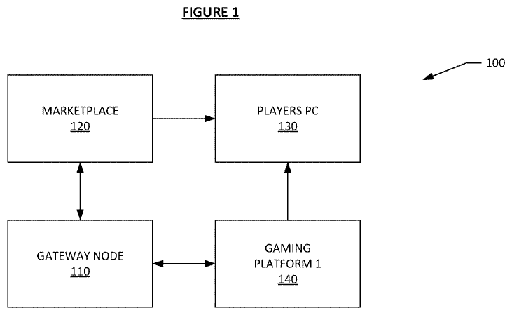

With reference to FIG. 1 a system 100 in accordance with some embodiments of the present invention will now be discussed. System 100 may comprise at least four components, a gateway node 110, in communication with a marketplace 120 and a gaming platform 140. A player's computer or PC 130 may be in communication with the marketplace 120 and the gaming platform 140.

The gateway node 110 may help provide and track products, digital assets, and other items provided to the player PC 130 by way of the marketplace 120 or gaming platform 140.

In addition, records of asset ownership, transfers, value accounts, etc. may also be stored in a distributed database, with records held by one or more of the gateway nodes 110, marketplace 120, players PC 130, and gaming platform 140. In situations where information pertaining to the marketplace 120 may not be desirable to share with the gaming platform 140, or vice versa, such information may be encrypted.

In accordance with some embodiments, and as discussed above, such information may also be stored in a blockchain arrangement, where information may be encrypted but distributed on a ledger accessible by all parties for verification purposes.

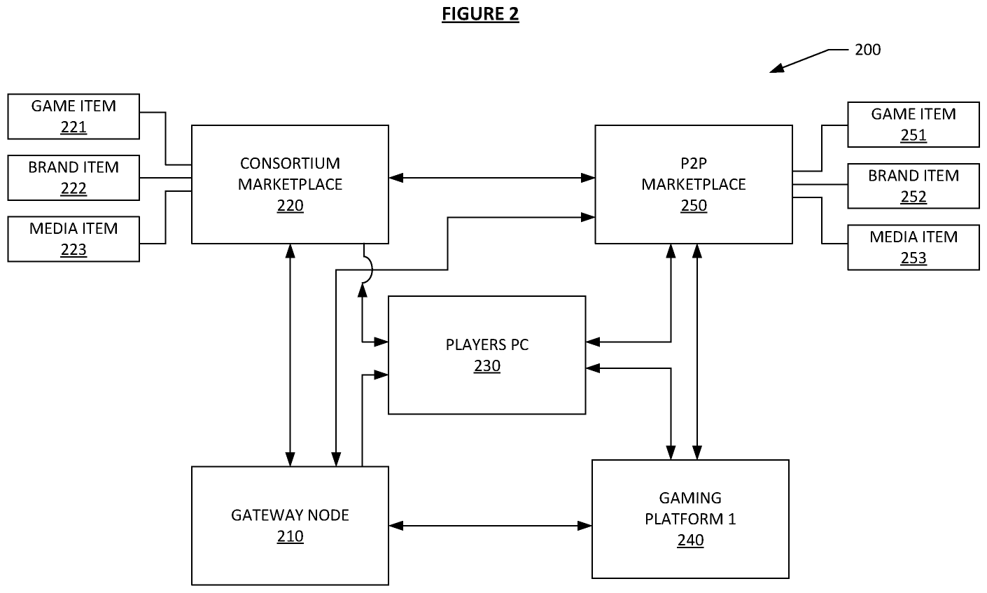

With reference to FIG. 2, a system 200 in accordance with some embodiments of the present invention will now be discussed. System 200 may comprise a gateway node 210, a consortium marketplace 220, a player's PC 230, a gaming platform 240, and a Peer-to-Peer (P2P) marketplace 250. The consortium marketplace 220 may comprise various items, such as a game item 221, a brand item 222, and/or a media item 223.

A game item 221 may be any item or asset that can be purchased, built, or otherwise used in a game. For example, a game item 221 may comprise a weapon or enhancement (e.g., for fighting games), a vehicle or enhancement (e.g., for racing games), tools or components (e.g., for building or sandbox games), skins or identities, etc.

A brand item may be an item that may be associated with, and offered by or in association with, a brand. For example, a brand item in a racing game may be a specific car—e.g., a Nissan z300. Or a player skin that is drawn from a franchise or brand (such as Captain America or Iron Man).

A media item may be a media item that may be used in game or in a gaming environment. This may include a song, movie, artwork, etc.

Note that it is possible for the items 221, 222, 223 discussed above to be combined. For example, a brand such as Marvel could provide a skin of Captain America, a weapon he can use, as well as artwork of his shield, or even a clip of a movie in which Captain America appears.

While the consortium marketplace 220 may be populated by items offered by providers, the Peer-to-Peer (P2P) marketplace 250 may offer items resold by players. Such items may comprise anything of value or ownership in a game or gaming environment, and may include, but are not limited to game items 251, brand items 252, and/or media items 253.

As noted above, records of asset ownership, transfers, value accounts, etc. may also be stored in a distributed database, with records held by one or more of the gateway nodes 210, marketplace 220, players PC 230, gaming platform 240, and P2P Marketplace 250. In situations where information pertaining to one party may not be desirable to share with a different party, such information may be encrypted.

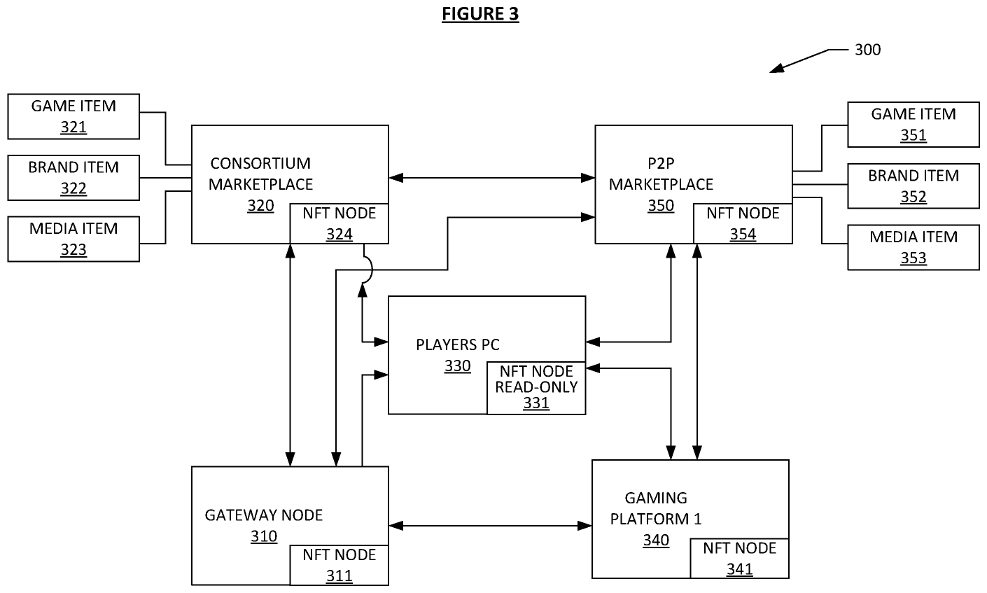

With reference to FIG. 3, a system 300 may again comprise a gateway node 310, a consortium marketplace 320, a player's PC 330, a gaming platform 340, and a Peer-to-Peer (P2P) marketplace 350. The consortium marketplace 320 may comprise various items, such as a game item 321, a brand item 322, and/or a media item 323. The Peer-to-Peer (P2P) marketplace 350 may offer items resold by players. Such items may comprise anything of value or ownership in a game or gaming environment, and may include, but are not limited to game items 351, brand items 352, and/or media items 353.

Notably, the gateway node 310, consortium marketplace 320, players PC 330, Gaming platform 340, and P2P Marketplace 350 may each further comprise a node for recording and tracking the existence of and transactions associated with digital assets. Each digital asset may be or be associated with a nonfungible token (NFT). Recordation of each NFT may be through a traditional database or a distributed database. A distributed database may still be centralized or controlled by a primary party, such as but not limited to Amazon Web Services. Alternatively, a distributed database may be decentralized, and records held, maintained, and confirmed by multiple parties. While FIG. 3 shows the parties being known and identifiable, it is also contemplated that nodes may be maintained by other, anonymous parties in order to provide confirmation of ownership.

The data in such databases may be traditionally stored or may be stored as sequential “blocks” of data, as discussed above. Because information in the blocks may be encrypted, each party (310, 320, 330, 340, 350) may maintain a full record, but may possess private keys to only decrypt data relevant to a specific party. Gateway node 310 may include NFT node 311; consortium marketplace 320 may comprise NFT node 321; players PC 330 may comprise NFT node 331; gaming platform 340 may comprise NFT node 341; and/or P2P Marketplace 350 may comprise NFT node 351.

In this manner, a gaming platform 340 may have access to its records and data but may also confirm the validity of the consortium marketplace's data through calculations verifying the blocks as valid, while being unable to read or modify the consortium marketplace's data. In one example, the players PC 330 may be able to decrypt and read information on the NFT node 331 pertaining to the player (or accounts associated with the player and/or player devices).

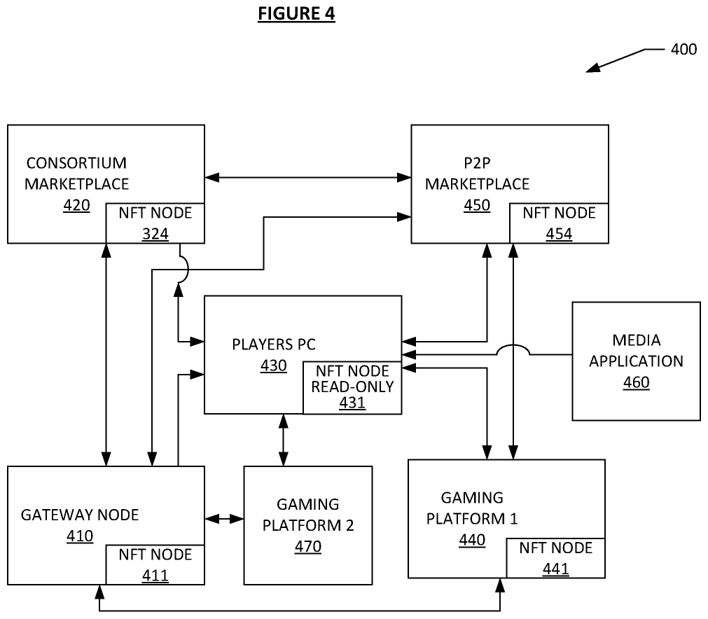

Note that the system of associated parties may grow, but not all parties may maintain or have access to NFT nodes. For example, with reference to FIG. 4 a system 400 will now be discussed. System 400 may comprise a gateway node 410 with NFT node 411; a consortium marketplace 420 with NFT node 421; a player's PC 430 with NFT node 431; a gaming platform 440 with NFT node 441; and a PTP marketplace 450 with NFT node 451. Additional parties, such as a media application 460 or a Second Gaming Platform 470 may also be part of the system but may not maintain NFT nodes for data maintenance or confirmation.

Verification of data in the system (consensus) may occur in any manner as known in the art. Proof of Work (PoW) may provide a consensus protocol when the parties do not trust each other—or as the number of parties with access to private (yet encrypted) data grows. Proof of Stake (PoS) may be used, but only for parties that are financially invested in the system, either through ownership and risk of an associated value (e.g., cryptocurrency), or other financial incentive. Proof-of-Location (PoL) may be used, if only to verify trusted sources of data synchronization. However, Proof-of-Authority (PoA) consensus may be the most desirable. PoA consensus may permit the primary parties—the gateway node, consortium marketplace, P2P marketplace, gaming platforms, etc. to act as validators and have authority to produce new blocks, only when a supermajority is reached by the validators.

This may permit the primary parties to add new blocks, while utilizing additional — and even anonymous nodes to verify the blocks.

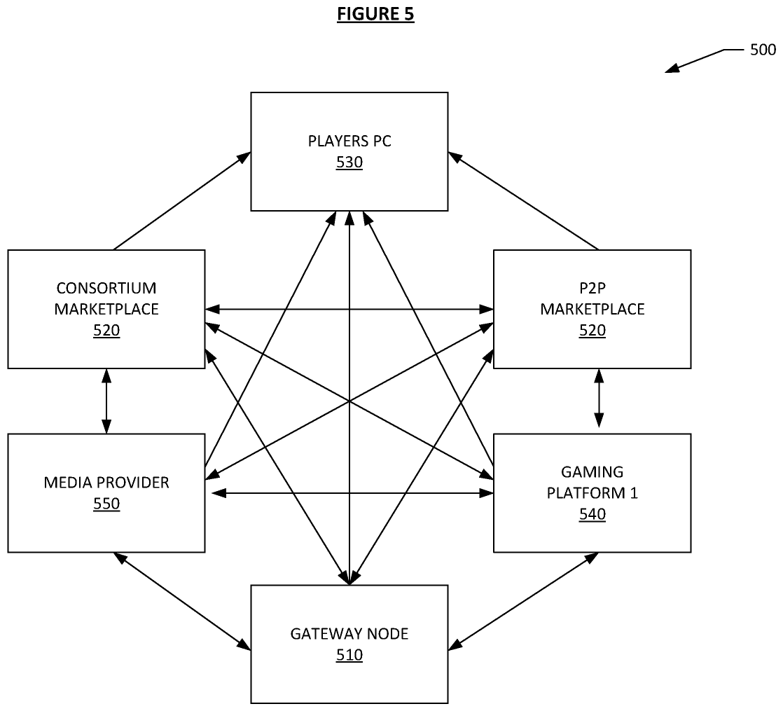

A communication arrangement 500 amongst a distributed ledger system may be seen at FIG. 5. Arrangement 500 illustrates that each party has direct communication to each other—and the ledgers and files are synchronous and shared amongst each party. The

Gateway Node 510, Consortium Marketplace 520, Players PC 530, P2P Marketplace 550, Gaming Platform 540, Media Provider 560, etc. may all access distributed nodes. Again, note that each party may not be able to decrypt all of the data on the nodes, but may be able to confirm the validity of the data through verification of data hashes (including relevant Merkle hashes).

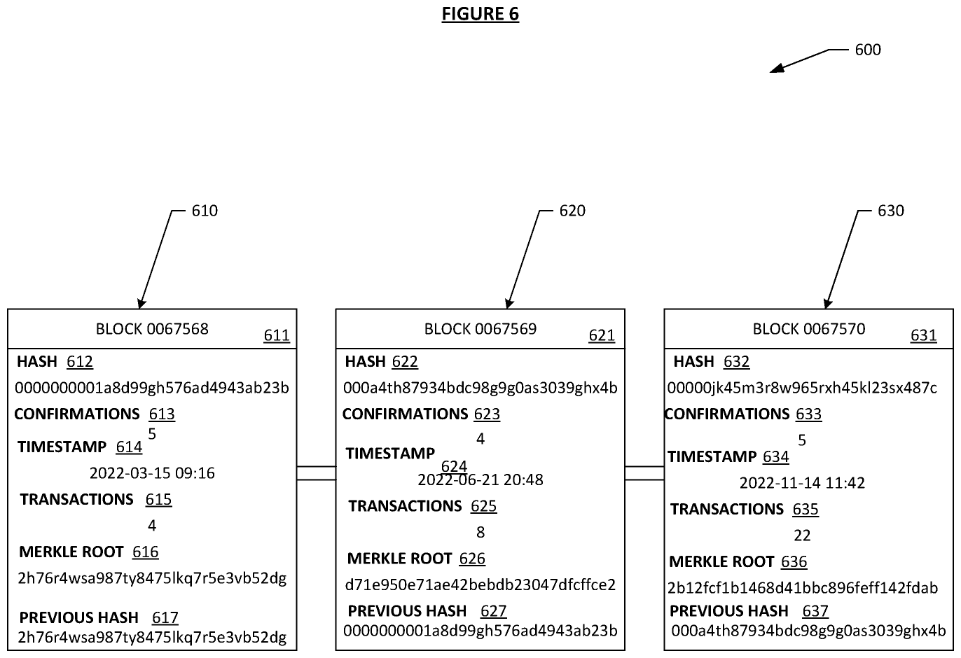

Data may be stored in blocks as graphically represented by flow 600 at FIG. 6. 600 may comprise three (3) subsequent blocks 610, 620, 630. Block 610 may be block number 0067568 (reference numeral 611) and may include the hash of the block at 612, a listing of the number of confirmations of the block at 613, a time stamp of block generation at 614, a listing of the number of transactions represented by the block 610 at 615, a hash of the Merkle root of the block at 616, and a hash of the previous block at 617. Block 620 includes the same information but has a unique hash for the block at 622, and specific confirmations 623, time stamp 624, and transactions 625 relevant to block 620. Merkle root 626 may then incorporate the hash (and history) of the previous block, and previous has 627 may be included.

Block 630 may continue the data structure and may include a unique hash for the block at 632, and specific confirmations 633, time stamp 634, and transactions 635 relevant to block 630. Merkle root 636 may then incorporate the hash (and history) of the previous block, and previous has 637 may be included.

Use Case 1—Virtual Assets Sold by Consumer Product Brands. In accordance with some embodiments of the present invention, a consumer product brand may sell virtual items to an individual buyer on a marketplace. The marketplace may be operated by or through a third party. Currency on the marketplace may be central bank issued money fiat or other alternative currencies, including but not limited to cryptocurrency, loyalty points, or a trade of other assets. To complete a sale, the marketplace may access an open application programming interface (API) which may provide services to complete registry of the individual buyer's purchase. A non-fungible token (NFT) may be generated for the virtual item and stored on a blockchain. The blockchain (which may be public, private, semi-private, etc.) may contain nodes maintained by brands, marketplaces, gaming hardware manufactures, gaming software providers and unrelated entities. Upon completion of the purchase and creation of the NFT associated with the virtual item, multiple virtual environments (game, video game, metaverse, or digital twin of a location) may then validate ownership of the purchased virtual item to unlock the ability to add, edit, remove, or trade virtual item in that virtual environment. Validation may be through any known consensus protocol.

For example, an automotive company such as Nissan™ may sell a z300 virtual car directly to a player. The Nissan z300 virtual car may then be authorized/unlocked for use by that player on one or more gaming platforms, and for one or more games, such as but not limited to, Grand Theft Auto, Need for Speed and Forza. In addition, the authenticity of the virtual car and the legitimacy of the player's ownership of the virtual car may be confirmed with reference to the distributed blockchain.

Use Case 2—Virtual Assets Sold by Gaming Platforms. In accordance with some embodiments of the present invention, virtual environment publishers, such as but not limited to game, video game, metaverse or digital twin of a location, may sell virtual items to an individual buyer within the virtual environment through a Marketplace. Virtual items may include, but are not limited to, music, video, graphics, badges, and other game assets. The marketplace may utilize currency—such as central bank issued money fiat or other alternative currencies including but not limited to cryptocurrency, loyalty points or trade of other assets. When completing this sale upon receiving payment from a buyer, the Marketplace may accesses an open API which may provide services to complete registry of the buyer's purchase and the creation of an NFT for the virtual items on a public blockchain. The public blockchain would contain nodes maintained by publishers, brands, marketplaces, gaming hardware manufactures, gaming software providers and unrelated entities. Upon completion of the purchase and creation of the NFT for said item the publisher (game, video game, metaverse, or digital twin of a location) could then validate ownership of the purchased virtual item to unlock the ability to add, edit, remove, or trade virtual item in that virtual environment. The platform may enable multi-factor authentication and enhanced security validation prior to the transfer or rental of virtual products (game assets) to prevent fraud risks. If there are any concerns related to account control or other fraud (on the part of the virtual environment publisher or the buyer) the virtual item would not be eligible to be used, rented, or transferred.

For example, a gaming platform may offer on a marketplace weapons, upgrades, vehicles, items, etc. that may be used in-game by players.

Use Case 3—User Selling Own Asset. In accordance with some embodiments of the present invention, an asset owner can sell a virtual asset to an individual buyer through a Marketplace which is operated by a third party for currency whether central bank issued money fiat or other alternative currencies including but not limited to cryptocurrency, loyalty points or trade of other assets. When the asset owner adds the virtual item(s) to the marketplace it makes a call to the public blockchain to validate ownership and completes dual authentication and enhanced security validation prior to allowing the post of the item. If approved, the individual buyer may see the product on the marketplace and may be able to initial a purchase. When completing this sale in the ecommerce experience and the individual buyer receives an approved payment response, and the Marketplace accesses an open API which provides services to revalidate ownership. A current NFT associated with the virtual asset may be used, or a new NFT may be generated for the virtual asset on the public blockchain, thereby completing the transfer to the new owner. As part of this process creators of virtual items such as brands, gamer publishers, gaming hardware manufactures, gaming software providers and other registered entities may be paid commission on the lifecycle events like transfers or rentals. Such a commission may be based on a smart contract residing within the blockchain and self-executed based on the lifecycle events occurring and based on negotiated rates. A blockchain may contain nodes maintained by publishers, brands, marketplaces, gaming hardware manufactures, gaming software providers and/or unrelated entities.

For example, a player may create a structure in a video game such as Minecraft™, and the structure may be imported into the game itself

Use Case 4—Virtual Assets Sold by Content Creator. In accordance with some embodiments of the present invention, content creators such as brands, game publishers, gaming hardware manufactures, gaming software providers and other registered entities could register virtual items (music, video, graphics, badges, and other game assets) on the blockchain. Such content may be made available to gaming platforms or a game publisher.

In some embodiments, a smart contract may execute once licensing terms have been accepted by a gaming platform or game publisher, and the content assets may be made available for validation across multiple platforms and virtual environments (for example, game, video game, metaverse, or digital twin of a location). Timing of availability may be based on the blockchain platform and configurations.

For example, a branded Nissan™ vehicle may be imported into a racing game.

Use Case 5—Asset Owner Renting or Loaning Item. In accordance with some embodiments of the present invention, an asset owner can rent or loan virtual items (music, video, graphics, badges, and other game assets) to an individual buyer through a Marketplace. Such a marketplace may be operated by a third party for currency, whether central bank issued money fiat or other alternative currencies including but not limited to cryptocurrency, loyalty points or trade of other assets. A purchaser may receives an approved payment response, and the Marketplace may accesses an open API, providing services to complete registry of the individual buyer's rental/loan. An NFT of the virtual item loaned or rented may be utilized, or a new NFT may be created for the limited use of the virtual items on a blockchain. Smart contracts may be embedded in the blockchain, and the NFT may be associated with the smart contract. In this manner, the owner may set limits such as duration, use, ability to modify, etc., and if such terms are breached the rental/loan may immediately terminate and return the virtual item to the owner. The blockchain may contain nodes maintained by brands, marketplaces, gaming hardware manufactures, gaming software providers and unrelated entities. Upon completion of the rental/loan purchase and creation of the NFT for said item multiple virtual environments (game, video game, metaverse, or digital twin of a location) may then validate ownership of the purchased virtual item to unlock the ability to add, remove the asset in that virtual environment. As part of this process creators of virtual items such as brands, gamer publishers, gaming hardware manufactures, gaming software providers and other registered entities could be paid commission on the lifecycle events like rentals and loans. This commission would be based on a smart contract which resides within the public blockchain and trigger by the lifecycle events occurring and based on negotiated rates.

For example, a virtual asset owner may rent a specific vehicle to a player through a marketplace. During the rental, control of the asset may be in the hands of the renter, and the virtual asset owner may not be able to access or utilize the asset. The renter may use the car in their own game(s), provided he or she abides by the terms of the rental agreement, which has been written as executable code in a smart contract. Should the renter violate these terms, access to the virtual asset is immediately terminated and control is returned to the owner.

Use Case 6—Brand Loyalty Rewards. In accordance with some embodiments of the present invention, a buyer may be entered into an loyalty program when the buyer completes a purchase of a virtual item (music, video, graphics, badges, and other game assets) through a Marketplace. Because of the buyer's preference or affinity for the brand, the buyer may be offered targeted promotions via a smart contract sitting on top of the blockchain.

For example, a buyer may purchase a virtual Nissan™ Z300 to use in a racing game. The buyer may be asked if he or she would like to join a loyalty program or tie the sale to an existing loyalty program membership. Once this purchase is effectuated, a smart contract may execute which may immediately offer the buyer special financing opportunities on a physical, real, Nissan™ Z300, receive discounts at a Nissan Service Center, gain bonus loyalty points, or even receive a die cast model of the real-world car. The blockchain may be updated with the buyer's loyalty and communication preferences via an API call. If an individual buyer has an existing loyalty account and make another purchase the association with the previous account will occur.

In this use case the loyalty platform may have access to the distributed ledger to identify owners of a specific asset with a specific brand. This information may then be used to directly market to such parties. When an offer is redeemed, the brand's agent, location, or subsidiary's mobile application, chatbot, POS or other devices may call into the public blockchain to validate whether the asset is still owned by the buyer, thus preventing unauthorized use or abuse of the promotion.

In addition, it is known in loyalty programs to provide exchange rates with loyalty points or values from different loyalty programs (for example, exchanging airline “miles” for gift cards). However, tokenizing loyalty programs into a digital token on a blockchain may provide a mechanism for ownership transfer and a secondary market. Using smart contracts and blockchains, users may transfer loyalty points without the need of intermediaries. For example, loyalty points or rewards may be tokenized, and then may be redeemed on a variety of business platforms amongst cooperating merchants or retailers. Ownership of the points by a user would be clear to all parties, as would relevant balances, previous transfers, etc. Tokenization of rewards may result in rewards being redeemable amongst different parties, be transferable, etc.

Use Case 7—Virtual Assets Listed in Multiple Markets. In accordance with some embodiments of the present invention, virtual items (music, video, graphics, badges, and other game assets) may be listed for sale simultaneously across multiple marketplaces. Marketplaces may be operated by a brand or by third parties. The listing for sale may reside on a distributed ledger, and accordingly many sites or marketplaces may use the information on the blockchain to populate their marketplace. For example, third parties may cull specific information from the public ledge to white label information to reach niche audiences. Ownership of the virtual asset may be recorded and available on all blockchain nodes. Additionally, as needed a smart contract may be utilized to limit the quantities available once a defined threshold has been reached.

For example, a player may create a modified vehicle to be used in a racing game. The player record the virtual asset and proposed sale on a distributed ledger, or blockchain. Various parties may maintain nodes of the ledger, and may offer the modified vehicle for sale to their specific customers. Once purchased by one party or once a certain number of sales has been met, the virtual asset may be removed from being available for purchase.

In addition, this use case may apply to virtual assets such as music, which may be purchased or streamed after ownership of the music is authenticated.

Use Case 8—User Authenticated and Virtual Assets Streamed. In accordance with some embodiments of the present invention, an API service may be provided to poll blockchain based at least in part on an asset owner's identifier, to validate and provide access to music from streaming services such as Apple Music™, Amazon Music™, Pandora™, and/or others. The user's identity and access to such streaming assets may be validated and access confirmed via reference to the blockchain.

Use Case 9—Trading of Virtual Assets. In accordance with some embodiments of the present invention, an individual asset owner may decides to barter or trade an existing virtual item (e.g., music, video, graphics, badges, and other game assets, etc.) with another individual buyer for other assets, and the transaction may leverage a blockchain platform for a predetermined transfer fee. In this specific use case, a purchase or trade may occur in a virtual environment (e.g., game, video game, metaverse, or digital twin of a location, etc.) which both parties are members of and would enable the transaction to occur within. It is also contemplated that a trade may be made on a marketplace, where each party may establish threshold “values” or items that they are willing to trade for. Such terms may be coded as smart contracts such that when a match is found, it may automatically execute and ownership of the assets may trade.

Completing this activity may eliminate any rights of the original individual asset owner and payment may be made through execution of smart contract. In some embodiments, the former asset owner may enter a new virtual environment and acquire a new virtual item (music, video, graphics, badges, and other game assets) for that publisher in payment for the trade.

For example, a player may own a sword in Roblox, and may trade it for a sword in Fortnite. This trade may be with another party, or may be with the gaming platform itself

Use Case 10—Virtual Trophy Case. In accordance with some embodiments of the present invention, a virtual trophy case may be maintained. A digital locker may hold and maintain accomplishments, achievements, and in-game awards for multiple virtual environments (game, health tracking, video game, metaverse, or digital twin of a location, etc.). A virtual museum or hall of trophies across varied environments may would persist well beyond any single environment, and may be maintained even if a gaming platform terminates or goes offline. For example, top or best attributes of game play, and/or a record of such game play may be stored in a blockchain for all time and the associated awards added to a digital locker. A user may then review the blockchain data and revisit saved and/or impressive gameplay, or their records over time. With this solution there may be additional features, such as providing metrics of performance over time, detailed stats analytics, and recommended training plans. In this solution, an API may be provided for the virtual environments to post the transactions to the blockchain as well provide any awards a player may have achieved. There may also be an API to pull digital locker details to be displayed or award ownership validated.

For example, a player of Forza racing games may maintain a record of all wins, top times, top speeds, etc. The record may be merely validated data showing the records, or may include video clips of gameplay, trophies, awards, etc.

Finally, it also contemplated that non-fungible token may be used to identify a specific customer—without including personally identifiable information. Once a customer's identity has been tokenized, aspects of tracking the customer's interactions with various merchants, retailers, other customers—be it buying, selling, or trading digital or virtual assets—may be monitored and monetized. A token representing a customer may be associated with one or more loyalty or brand programs, which may be merchant or retailer specific, or may extend across multiple retailers or channels of trade. In this manner, a customer may bring his or her own loyalty program with the customer during any transaction. A customer's token may be associated with a variety of programs, ranging from travel programs to retailer loyalty programs, from collegiate alumni associations to professional or social groups. During a transaction, the customer's token may be accessed and associated programs reviewed for any applicable and/or matching programs. Such programs may then be accessed, and points awarded, discounts provided, or whatever is actionable from according to rules (for example, smart contracts) associated with each relevant program.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense.

What is claimed is:

1. A method of transferring ownership of a virtual or digital asset between a provider of the asset, a receiver of the asset, and multiple nodes in a distributed file system, the method comprising:
assigning a non-fungible token (NFT) to the asset;
recording the NFT on the distributed file system;
receiving a request for transfer of the asset from the provider to the receiver;
confirming ownership of the asset by reviewing the NFT record on one or more nodes in the distributed file system;
transferring ownership of the asset from the provider to the receiver;
updating the NFT record on one or more nodes in the distributed file system to reflect receiver as the owner of the asset;
confirming the receiver as the owner of the asset by one or more other nodes in the distributed file system.

2. The method of claim 1, wherein the virtual or digital asset is a video game asset, comprising a graphic, character, environment, logo, music, weapon, tool, special effect, sound effect, artwork, armor, potion, skin, and/or other aspect used in a video game.

3. The method of claim 1, wherein the distributed file system is a decentralized, distributed ledger system.

4. The method of claim 3, wherein the NFT is stored in a blockchain on the decentralized distributed ledger system.

5. The method of claim 1, wherein ownership of the asset is confirmed by reviewing the distributed file system and determining a consensus of ownership by multiple nodes.

6. The method of claim 1, wherein the request for transfer of the asset is received before the asset is conveyed from the provider to the receiver.

7. The method of claim 1, wherein the request for transfer of the asset from the provider to the receiver is a temporary transfer of the asset, limited to a specific time-frame.

8. The method of claim 7, wherein terms of the temporary transfer of the asset from the provider to the receiver is governed by smart contracts, which automatically return ownership to the provider after the time-frame expires.

9. The method of claim 7, wherein during the time-frame of the temporary transfer of the asset, the provider cannot transfer, access, or otherwise use the asset.

10. The method of claim 1, wherein updating the NFT record on one or more nodes comprises generating an additional block of data corresponding to the NFT, and distributing this additional block of data to one or more nodes in the distributed file system.

11. The method of claim 1, wherein confirming the receiver as the owner of the asset by one or more other nodes comprises reaching a consensus amongst the nodes.

12. The method of claim 11, wherein the consensus is of a type selected from proof of work, proof of stake, proof of location, or proof of authority.

13. The method of claim 1, wherein the provider of the asset is a video game platform.

14. The method of claim 1, wherein the provider of the asset is video game player who created the asset.

15. The method of claim 1, wherein the provider of the asset is a party who owns title to the asset, but did not create the asset.
